(19) United States
(12) Patent Application Publication
(10) Pub. No.: US 2026/0050749 A1
(43) Pub. Date: Feb. 19, 2026

(54) GLOBAL CONTENT MANAGEMENT

(71) Applicant: Paypal, Inc., San Jose, CA (US)

(72) Inventors: Aarti Ashok, San Jose, CA (US); Derrick Allen Stout, Arlington, VA (US); Jillian Kay Kinkeade, San Jose, CA (US); Nitin Kishen Choweth Vijayakumar, Fremont, CA (US); Ulrike Irmler, Weinheim (DE)

(21) Appl. No.: 18/808,845

(22) Filed: Aug. 19, 2024

(51) Int. Cl. G06F 40/55; G06F 40/51

(52) U.S. Cl. CPC G06F 40/55; G06F 40/51

(57) ABSTRACT

A method for adapting content for multiple targets may include receiving a document from a user computing device, the document comprising a plurality of text portions, tagging, via a first machine learning model, each of the plurality of text portions as either dynamic or static based on at least one characteristic of the respective text portion, receiving, from the user computing device, an indication of a content parameter, generating, via a second machine learning model for each of the plurality of text portions tagged as dynamic, a replacement portion based on the content parameter, and transmitting, to the user computing device, an updated document comprising a plurality of replacement portions and the plurality of text portions tagged as static.

### TECHNICAL FIELD

The instant disclosure relates to utilizing artificial intelligence (AI) to adapt content for different audiences.

### BACKGROUND

The prevalence of the internet has introduced a great deal of global interconnectivity. This means, in part, that anything published in one corner of the world may be accessed by anyone with an internet connection. Such interconnection extends to businesses and product offerings too, as the internet has fostered a truly global marketplace in which someone can offer goods for sale to the entire world.

### BRIEF DESCRIPTION OF THE DRAWINGS

FIG. 1 is a block diagram of an example system for adapting content to different targets.

FIG. 2 is a sequence diagram of an example workflow of the example system of FIG. 1.

FIG. 3 is a flow chart illustrating an example method of the example system of FIG. 1.

FIG. 4 is a flow chart illustrating an example method of the example system of FIG. 1.

FIG. 5 is a flow chart illustrating an example method of the example system of FIG. 1.

FIG. 6 is a diagrammatic view of an example embodiment of a user computing environment.

### DETAILED DESCRIPTION

In order to adapt content for different targets (e.g., users, markets, jurisdictions, etc.), entities have often relied on localization teams who take original content and edit the content to account for local regulations and requirements. This process requires a combination of institutional knowledge (e.g., innate understanding) and “substitution” tables that outline one-to-one replacements for words that may be acceptable (e.g., understood, translatable, allowed) for one target but not another. Due to this difficult combination of factors, this localization process can be error-prone and inefficient. For example, the substitution tables contain a mixture of historical adaptations, spelling corrections, and changes that lack authority and transparency, which can make the tables difficult to apply. Furthermore, requiring strict one-to-one replacement can lead to grammatical and logical errors, while allowing more adaptability or autonomy for localizers can slow the process and lead to different errors.

The present disclosure may find use with a wide variety of content. For example, the instant disclosure may find use with communications (e.g., emails or text messages), web pages, application menus and interfaces, advertisements, and the like. An entity or organization may generate a huge number of such communications, pages, interfaces, etc., and thus manual review and modification of such content is practicably impossible. Furthermore, by automating the generation of context-specific content and personalized content at the time of serving the content to the user, the instant disclosure provides a unique set of computing resources and computing architecture for content generation.

A system according to the disclosure herein addresses these shortcomings by utilizing artificial intelligence (AI), like machine learning (ML), to identify portions of content that would be acceptable for all targets (e.g., “static” content) and portions of content that can be customized for a particular location, user, etc. before being distributed to different targets (e.g., “dynamic” content). AI-based dynamic content identification may further identify the type of dynamic content, in some embodiments (e.g., a recipient name, a recipient address, a location-specific query, etc.). The system may tag the dynamic content for replacement (e.g., using localized and/or personalized content replacement), and may further leverage AI (e.g., a generative AI model) to produce replacement content for the dynamic content. For an example in which content is to be sent to individual users, the system may identify the salutation (e.g., introductory greeting) as dynamic content, and may replace each instance with the respective user's name, as well as any location-specific substitutions (e.g., a different greeting to match geographic customs of different regions).

“Dynamic” content, as used herein, may refer to two different kinds of information. A first type of dynamic content is contextual dynamic information, where particular content differs according to broad context, such as the geographic region in which the content will be consumed. A second type of dynamic content is personalized dynamic content, where particular content differs according to specific characteristics of an intended user to whom the content is directed. In some embodiments, appropriate text to fill in each type of dynamic content may be determined at different portions of a content generation process, as will be described below.

By identifying dynamic content portions and generating replacement text for those dynamic content portions using AI models, the instant disclosure significantly speeds the development of adapted content for user-facing documents. For a large organization, which may regularly generate thousands or tens of thousands of communications, interface flows, and other documents, the approach of the present disclosure may significantly reduce burden on developers. Further, the approach of the present disclosure improves the functionality of a backend computing system by enabling the backend system, at runtime, to efficiently present dynamic content to users without a large storage or computing burden that slows response times to the user.

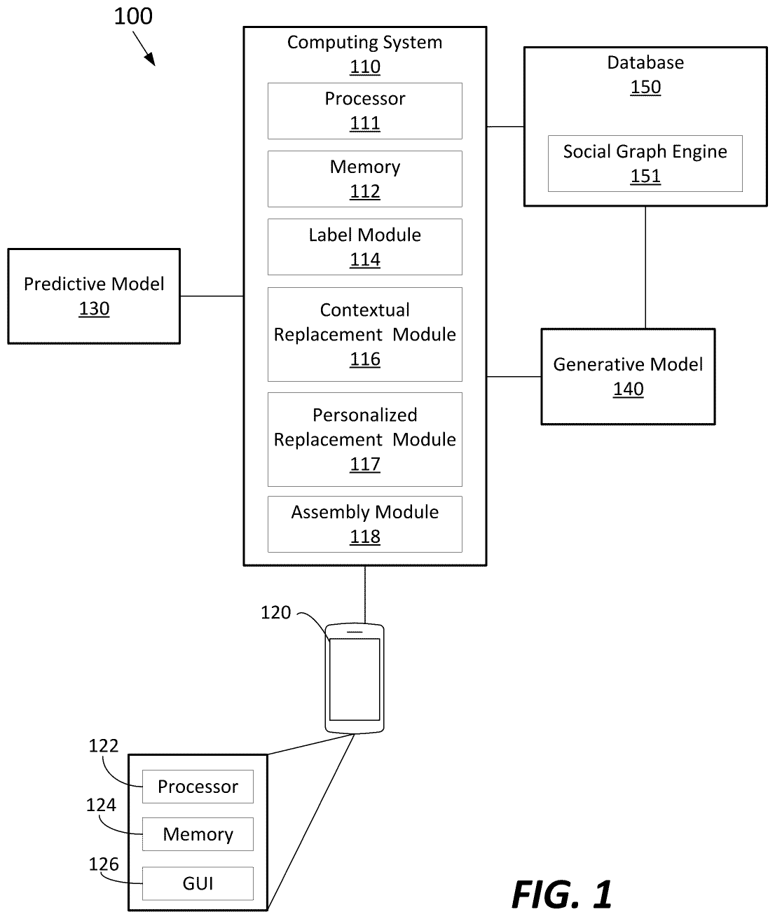

Referring to the drawings, wherein like reference numerals refer to the same or similar features in the various views, FIG. 1 is a block diagram of an example system 100 for adapting content for different targets. As shown, the system 100 may include a computing system 110, a user device 120, a predictive ML model 130, a generative ML model 140, and a database 150, each of which may be in electronic communication with one another and/or with other components via a network. The network may include any suitable connection (or combinations of connections) for transmitting data to and from each of the components 110, 120, 130, 140, 150 of the system 100, and may utilize one or more communication protocols that dictate and control the exchange of data.

As shown, the computing system 110 may include a processor 111 and a memory 112 (i.e., a non-transitory, computer-readable medium) storing instructions that, when executed by the processor 111, cause the computing system 110 to perform one or more methods, operations, functions, algorithms, etc. of this disclosure. The computing system may include one or more functional modules 114, 116, 118 embodied in hardware and/or software. In an embodiment, the functional modules of the computing system 110 may be embodied as instructions in the memory 112.

The modules 114, 116, 117, 118 may collectively receive requests for, and output in response, adapted content for transmission to multiple different targets. For example, the computing system 110 may receive a generalized portion of content that is to be sent across the world to global users and may process and edit the content to ensure accuracy in translation-both literal (e.g., correct terms for the target) and figurative (e.g., complying with local regulations). In addition to accurate literal and figurative translation, the modules 114, 116, 117, 118 may also customize the content for the characteristics of individual users or user types.

The user device 120 may include a processor 122 and a memory 124, which may be any suitable processor and memory. In particular, the user device 120 may be a mobile device (e.g., smartphones, tablets, laptops, etc.). The memory 124 may store instructions that, when executed by the processor 122, cause a graphical user interface (GUI) 126 to display on the user device 120. This GUI 126 may be provided, in part, by the computing system 110 and, particularly, one or more of the functional modules 114, 116, 117, 118. The GUI 126 may enable the generation of initial content, and may present the adapted content. The GUI 126 may also enable other user actions, including providing an interactive element for intermediary actions (e.g., progress reports, status checks, etc.) and providing an opportunity for the user to provide feedback on the adapted content (e.g., to correct a mistranslation, etc.).

The predictive model 130 may be any suitable model capable of predicting, estimating, or guessing a future value based on an input. The predictive model 130 may be trained using pairs of inputs and outputs, from which the predictive model 130 may extract (or derive) cause-and-effect relationships between the inputs and outputs in order to predict an unknown output for a known input. In some embodiments, the predictive model 130 may be trained using data that associate portions of content with a corresponding label (e.g., “static” or “dynamic”), such that the predictive model 130 may “learn” to label received content with labels. Although reference herein will be made to a single predictive model 130, it should be understood that this disclosure includes any number of models within the predictive model 130. For example, an individual predictive model 130 may be trained for each type of content (e.g., advertising copy, disclosure letter, etc.)

The generative model 140 may be any trained (e.g., pre-trained) model capable of generating content in response to a prompt, such as a large language model (LLM). In some embodiments, the generative model 140 may be trained to generate replacement content for portions labelled as “dynamic” by determining an aspect of the portion that caused the portion to be labelled as dynamic (in those instances in which the predictive model 130 does not specify), retrieving any information necessary to adapt the portion of content (e.g., user names, local regulations, etc.), and generating the replacement content. Further, the generative model 140 may be trained to generate a type label for content portions labelled as dynamic by the predictive model. For example, the generative label may generate a label of “Name”, “Address”, “Salutation”, “Use Instructions”, etc. In some embodiments, the generative model 140 may include at least two models-a first model for generating content type labels, and a second model for generating content itself.

The database 150 may be any suitable database or data storage component configured to digitally house data for use by the computing system 110 and, particularly, the generative model 140. In some embodiments, the computing system 110 may receive data from the database 150 in response to requests from the computing system 110, and the computing system 110 may send data to the database 150 for storage. As noted above, the database 150 may be configured to provide a centralized resource for maintaining a directory of local regulations and user characteristics that may be leveraged by the generative model 140 to produce replacement content. Accordingly, the database 150 may be based on the substitution tables of current localization processes.

The database 150 may store, for each of a plurality of different content types, respective content specific to one or more contexts (e.g., geographic regions, times of day, months, weeks, etc.). The database may further store, for each content type, a default value, where the default value may be used where a context-specific version is not required.

As shown, the database 150 may include a social graph engine 151 configured to leverage information from the database 150 to determine (or infer) connections between entries. In those embodiments in which each entry of the database 150 corresponds to a geographical location, the social graph engine 151 may fill in gaps in some entries based on inferred relationships between geographical locations, such as having some shared local regulations, having a shared border, having similar demographics, etc. For example, if the database 150 is missing demographic information for a particular country, the social graph engine 151 may fill in the missing information with demographic information from a neighboring country. In those embodiments in which each entry of the database 150 corresponds to a particular user, the social graph engine 151 may fill in user preferences, experiences, needs, etc. based on users identified to be similar.

In some embodiments, the social graph engine 151 may complete data entries based on other datapoints known for a particular user. For example, if there is no address listed for a user in the database 150 but there are recurring charges at a grocery store in Dublin, Ireland, the social graph engine 151 may fill in the address datapoint by extrapolating from the known data (e.g., the user's recurring charges). In another example, the social graph engine 151 may derive data regarding a user by extracting or accessing data on the user's device (which is known in the database 150). In particular, the social graph engine 151 may data-mine preferences, tendencies, habits, or other patterns attributable to the user by analyzing the device. These data-mined preferences may then guide one or more modules of the computing system 110.

The functional modules 114, 116, 117, 118 may include a label module 114 configured to divide received content into portions and communicate with predictive model 130 in order to assign a label to each divided portion. The label may be indicative of whether the respective portion is dynamic or static. To identify portions, the label module 114 may utilize any suitable text recognition tool, such as Optical Character Recognition (OCR) and computer vision (CV). In some embodiments, the label module 114 may first identify each individual word or term in the received content and may group the individual terms into portions for labelling. The label module 114 may utilize a ML model to group the terms into portions based on similarity to portions of data on which the model was trained. In some embodiments, the label module 114 may also identify a position, orientation, and/or relative location of the individual terms (or overall content) within to inform the groupings. For example, the overall content may be positioned at a relative top of a document, which may indicate to the label module 114 that the content is a document header. In another example, the individual term may be position at the relative beginning of the content, which may indicate to the label module 114 that the term is a name or article of address.

As noted above, these labels may, in some embodiments, be “static” for those portions of the content that are acceptable for all targets and “dynamic” for those portions of the content that may not be acceptable for all targets. “Acceptable” may refer to the applicability of the portion for a respective target based on an aspect of the target. In those examples in which the aspect is a geographical location, an acceptable portion may be a portion that is compliant with all local regulations (e.g., includes proper identification of the source), that uses local verbiage (or fails to use foreign verbiage), and/or that does not extend an offer that would violate local requirements (e.g., offering a loan with an interest rate above a legal limit). In those examples in which the aspect is a user identity, an acceptable portion may be a portion that does not refer to the user at all (such that the portion would apply to any user). In some embodiments, the label module 114 may label a portion as “static” in response to determining that the portion would be acceptable for all targets, and may label a portion as “dynamic” in response to determining that the portion would be unacceptable for at least one target.

The label module 114 may utilize predictive model 130 to assign labels to content portions. In particular, the label module 114 may generate prompts for the predictive model 130 that include a respective content portion and an instruction to identify the portion as “static” or “dynamic.” In some embodiments, the label module 114 may include additional context within the prompt, such as a type of content from which the portion was divided, a position of the portion within the overall content, an intended target scope (e.g., a limited list of targets to narrow range of acceptability), or other information about the portion. In some embodiments, the label module 114 may supplement the prompt with additional instructions, such as an instruction to indicate the target(s) and/or aspect of the target(s) that caused the model 130 to identify the portion as dynamic (e.g., what local regulation would render the portion unacceptable).

In some embodiments, the label module may generate, for an input file, a source content file in which each content portion of the input file is represented by a value and a label. An example content file portion for a header of an input file follows:

```
welcomeHeader.json
[
  {
    value: “Glad you've joined us, {name}. Feel free to look around.”,
    content_type: “Header”
  }
]
```

Notably, in the example above, the entirety of the value is a dynamic content portion, with a specific dynamic content type of {name} within the larger portion of text.

In some embodiments, the label module 114 may label a portion of content as “dynamic” by replacing the portion in the content with a placeholder text that identifies the type of dynamic content. For example, in response to determining that a portion of content is a user's name, the label module 114 may replace that portion of the content with the placeholder “{name}” which may be used by the replacement module 116 to craft the appropriate replacement content. The placeholder may be generated by the generative model 140, in some embodiments.

The predictive model 130 may be model that is specially-trained to identify content portions as static or dynamic. To this end, the predictive model 130 may be trained using a dataset that includes a set of text portions with a label (e.g., “static” or “dynamic”) corresponding to each text portion. By inputting a portion into the predictive model 130, comparing the output from the model 130 to the label in the training data, and adjusting at least one parameter of the model 130 based on the comparison, the predictive model 130 may be trained to identify content portions as static or dynamic. In some embodiments, the training data may further include context for each training text portion in order to train the predictive model 130 to account for context.

The functional modules 114, 116, 117, 118 may include a contextual replacement module 116 configured to fill in contextual dynamic content portions. For example, the contextual replacement module may retrieve content appropriate for a particular region or other context from the database 150 and add that context-specific content to the output. Additionally or alternatively, the contextual replacement module may prompt the generative model 140 to produce content appropriate for the particular region or other context.

In some embodiments, the contextual replacement module 116 may receive the content file, parse the content file for contextual dynamic content (e.g., based on labels indicative of contextual dynamic content), and determine appropriate content for each contextual dynamic content item. For example, for each contextual dynamic content item, the contextual replacement module 116 may attempt to retrieve a context-specific content version from the database 150 and, if none is available, retrieve a default content version from the database, and fill in the appropriate content version in the output file. For some types of contextual dynamic content, the contextual replacement module may prompt the generative model 140 to generate context-appropriate content.

The functional modules 114, 116, 117, 118 may include a personalized replacement module 117 configured to fill in personalized dynamic content portions. The personalized replacement module 117 may retrieve personalized content, such as a name, from information respective of an intended recipient. Additionally or alternatively, the personalized replacement module may prompt the generative model to generate content specific to a user based on characteristics of that user, and add the generated content to the output.

In some embodiments, the replacement modules 116, 117 may receive an indication for some or all intended targets associated with a single content, such that the replacement modules 116, 117 may generate adapted content for multiple intended targets in a single job (e.g., adapting in batches). In some embodiments, the replacement modules 116, 117 may receive an indication of a single target for content, such that the replacement modules 116, 117 may generate adapted content in single target increments (e.g., adapting on-demand). For example, the system 110 may adapt a document in real-time in response to a user attempting to access the document. In these instances, the document being accessed by the suer may be marked internally as a “form” document (e.g., a template intended to be completed with targeted information), such that a user's attempt to access the document may trigger the computing system 110 to generate adapted content for the user to view.

As noted above, the replacement modules 116, 117 may assemble prompts for generative model 140 that, when received by generative model 140, cause the generative model 140 to produce content capable of replacing the content portion(s) labeled as “dynamic.” This replacement content may be “acceptable” for the target, as described above. To do so, the generative model 140 may be in communication with database 150 in order to leverage data stored on various targets for generating replacement content. For example, a prompt assembled by the replacement modules 116, 117 may include an indication that the target for content is a particular user, and the generative model 140 may query, pull, or rely on data associated with that particular user and stored in the database 150. In some embodiments, the generative model 140 may be trained using data stored in the database 150, such that the generative model 140 may be able to respond to prompts using data from the database 150 without having to query the database 150.

The functional modules 114, 116, 117, 118 may include an assembly module 118 configured to synthesize adapted content based on content portions labelled by the label module 114 as sufficiently generalized (e.g., “static”) and replacement content generated by the replacement module 116. In those embodiments in which the label module 114 labels content portions by replacing the portions with placeholder text (e.g., [NAME]), the assembly module 118 may assemble the adapted content by swapping in the replacement content for the placeholder text. In those embodiments in which the “dynamic” content is handled separately from the “static” content, the assembly module 118 may assemble the adapted content by ordering the “static” content and the replacement portions based on their order in the original content.

In some embodiments, the assembly module 118 may perform one or more grammatical- or logical-checks on the adapted content to reduce the likelihood of errors and mistranslations. Particularly given that the assembly module 118 may be combining disparate portions of content (e.g., content that were produced individually and separately), the assembly module 118 may process the entire assembled content with any suitable grammar-checking tool to confirm proper syntax.

In some embodiments, the assembly module 118 may review the acceptability of the content based on the intended target(s). Given the importance of aligning content with local regulations, the assembly module 118 may, in effect, double-check the replacement modules 116, 117. As noted above, “acceptable” content may refer to content that is in compliance with local regulations, which may define possible commercial offerings and terms for conducting transactions. Accordingly, the assembly module 118 may compare the content of the adapted content with local regulations for the particular target (e.g., by retrieving the local regulations from the database 150).

The assembly module 118 may output the assembled, checked, and adapted content. In some embodiments, the output may be a file, interface, etc. transmitted to the user device 120 for displaying (e.g., on GUI 126). In some embodiments, the output may be a file stored for later use (e.g., by a developer). For example, where the computing system 110 is applied to a user interface flow, the output may be a configuration file and content file for the interface flow. The assembly module 118 may include instructions for one or more interactive elements that a developer may interact with to provide feedback on the adapted content.

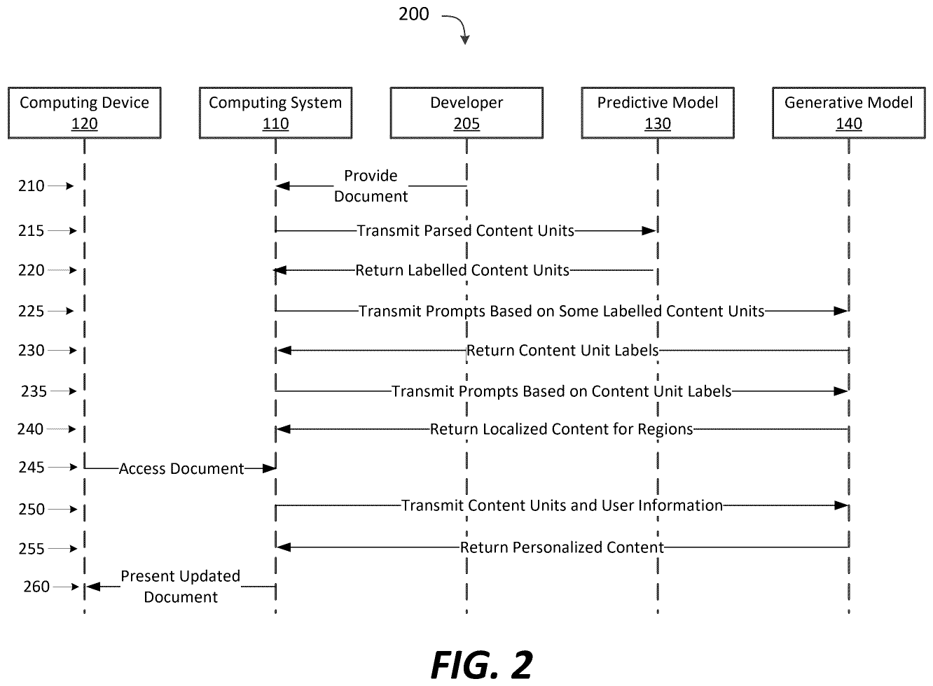

FIG. 2 is a sequence diagram illustrating an example workflow 200 of the system 100 of FIG. 1. As shown, the workflow 200 may begin at operation 210 with the computing system 110 receiving a document from a developer 205. The document may be content or may contain content for adapting to multiple targets. For example, the document may be a user interface flow. In addition to the document, the computing system 110 may receive one or more instructions (e.g., intended targets) from the developer 205. In some embodiments, the computing system 110 may extract or derive intended targets from an analysis of the document.

At operation 215, the computing system 110 may transmit, to the predictive model 130, content units that have been parsed from the received document. The computing system 110—and one or more modules of the computing system 110—may parse (or divide) the document into content units using any suitable natural language detection model to identify individual terms and then grouping those terms into the content units. In addition to the parsed content units, the computing system 110 may also translate instructions (or prompts) to the predictive model 130 that may be configured to guide the predictive model 130 output. For example, the prompts may specify one or more labels for the predictive model 130 to assign, and may indicate one or more targets for the predictive model 130 to account for when labelling.

At operation 220, the predictive model 130 may return labelled content units to the computing system 110. As noted in operation 220, the computing system 110 may transmit instructions to the predictive model 130 along with the content units, such that the labelled content units (or other returned output) at operation 230 may be responsive to the transmissions of operation 220.

At operation 225, the computing system 110 may incorporate some of the labelled content units into further prompts for generative model 140, and may transmit those prompts to the generative model 140. The content units included in prompts may be those units labelled at operation 230 as “dynamic” or as otherwise needing adaptation, localization, or amending in order to be acceptable to a particular target. The prompts may be generated with instructions and other content, such that the prompts may cause the generative model 140 to generate a classification label for a respective content unit. As such, the prompts may include an indication of the content unit as well as an instruction to classify the content unit. Such classifications may include, for example, a name field, an address field, a legal disclaimer field, a use instruction field, and so on. At operation 230, the generative model 140 may return the classifications for the content units to the computing system 110.

Following operation 230, the computing system 110 may store a version of the document in which each unit of dynamic text is represented by a variable or placeholder, as well as a classification label. As will be described below, when a user attempts to access the document at runtime, the computing system may retrieve or instruct the creation of replacement text for each dynamic content unit according to its classification label.

At operation 235, the computing system 110 may transmit further prompts to the generative model 140, where each prompt includes a dynamic content unit, its classification, and an instruction to generate content appropriate for a particular region, other location, or other context. The dynamic content units included in operation 235 may be those that are classified as contextually dynamic, such as fields that can be customized for each user in a given region. In some embodiments, operation 235 may include an instruction to generate replacement text for multiple regions or other contexts, such that multiple alternative replacement text portions may be generated for a given dynamic content unit. At operation 240, the generative model 140 may return the generated contextual dynamic text to the computing system 110. The computing system 110 may store the generated contextual dynamic text in memory. The generated dynamic text may be stored in conjunction with a default text, to be used where a user request does not match any context for which context-specific text has been generated for a given content unit.

Operations 235 and 240 may be performed in an offline process for each contextually dynamic unit in a given document to generate one or more replacement text portions for each contextually dynamic content unit. Those replacement text portions may be stored in conjunction with the context in which each should be used so that, when a user matching a particular context accesses the document in runtime, the contextually-correct dynamic replacement text may be retrieved, added to the document, and provided in the document to the user.

At operation 245, a user computing device 120 may access a document, via computing system 110, that was parsed for dynamic content units and for which contextually dynamic replacement text was generated. For example, where the document is a user interface flow for a website, operation 245 may include the user accessing the website via a browser. Where the interface is a server-supported application interface, operation 245 may include the user accessing the application on the computing device 120.

At operation 250, the computing system may transmit the content units classified as personalized dynamic, along with their classifications (e.g., a name field, address field, etc.), and known information about the user associated with the user computing device 120, to the generative model 140, with an instruction to generate personalized dynamic replacement text for each personalized dynamic content unit. Known user information may include user profile information (e.g., where the user has signed in to a profile), information stored in cookies or other local storage on the user computing device 120 and accessible to the computing system 110, and/or information provided by the user computing device 120 in previous interactions with the computing system 110. At operation 255, the generative model 140 may return the personalized dynamic content.

At operation 260, the computing system 110 may assemble the dynamic replacement content in the document, and may present the adapted document to the computing device 120 in response to the computing device accessing the document at operation 245. Before presenting the adapted content, the computing system 110 may perform one or more checks of the content, including a grammatical check (to ensure proper syntax) and a compliance check (to ensure acceptability in light of local regulations).

Assembling the adapted document at operation 260 may include, for each contextual dynamic content unit, retrieving contextual dynamic content from a store of dynamic content replacement portions. For example, as noted above, the computing system 110 may have stored alternative replacement text portions for different regions. In such an example, the computing system 110 may determine the region of origin of the computing device 120 request to access the document (e.g., according to an IP address from which the request originated, location information in a user's profile, etc.), and may retrieve contextual dynamic text matching that region. Where the determined region of origin does not match any generated dynamic text, the computing system may retrieve a default text. Each retrieved contextual dynamic text portion may be inserted into the appropriate portion of the document before presentation to the user. Assembling the adapted document at operation 260 may also include inserting the personalized dynamic content into the appropriate portions of the document.

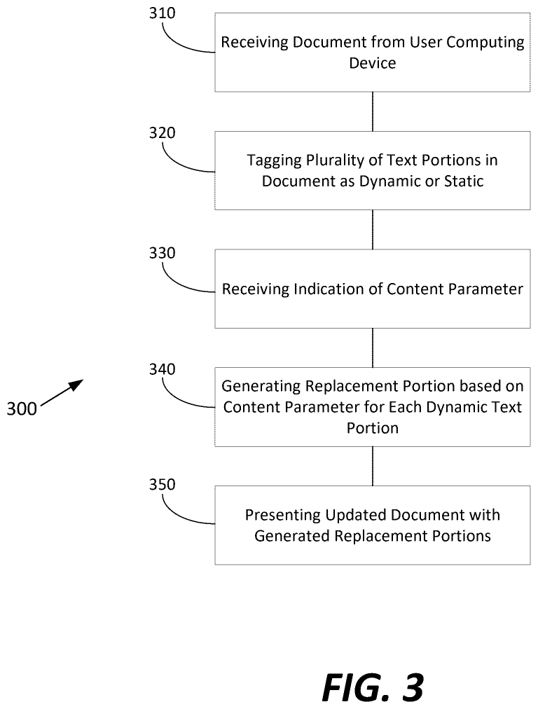

FIG. 3 is a flow chart illustrating an example method 300 of adapting content for multiple targets. The method 300, or one or more portions of the method 300, may be performed by the computing system 110 and, in particular, the label module 114, the contextual replacement module 116, the personalized replacement module 117, and the assembly module 118 (shown in FIG. 1), in some embodiments.

The method 300 may include, at block 310, receiving a document from a user computing device. The document may be or may contain an amount of content that is intended to be distributed to multiple targets. Accordingly, receipt of the document may also include receipt of one or more intended targets.

The method 300 may include, at block 320, tagging a plurality of text portions within the document as either dynamic or static. As described above, “static” content may be content that is acceptable for any target, while “dynamic” content may be content that is unacceptable for at least one target. In some embodiments, the tagging process may involve use of one or more trained AI models configured to identify whether a given input text is characteristic of static or dynamic parameters, and where dynamic, the type of dynamic content. In some embodiments, block 320 may include using a predicting AI model to identify dynamic content units, and a generative AI model to label the identified dynamic content units by content type.

The method 300 may include, at block 330, receiving an indication of a content parameter. This content parameter may be an aspect of one or more targets, such as a context of a request for a document and/or an identity of q requester. The indication may be received from a developer and/or from a user computing device in a document request. In some embodiments, the content parameter may be a user identity. In some embodiments, the content parameter may be a geographical location, or a regulation associated with the particular geographical location.

The method 300 may include, at block 340, generating a replacement portion based on the content parameter for each dynamic text portion (e.g., each text portion labelled as “dynamic”). In some embodiments, the replacement portion may be generated by a specifically-trained AI model that may generate replacement content in response to a prompt that specifies the original content and the content parameter.

Block 340 may include generating replacement portions for both contextual dynamic portions and for personalized dynamic portions. As discussed in connection with FIG. 2, contextual dynamic portion replacement text may be generated and stored for use in an offline process, and personalized dynamic replacement text may be generated at runtime.

The method 300 may include, at block 350, presenting an updated document with generated replacement portions. The updated document may include a one-to-one replacement of each portion tagged as dynamic with a corresponding replacement portion. In some embodiments, the updated document may be checked for accuracy and compliance prior to presentation. The updated document may be assembled and presented in response to a user request to access the document.

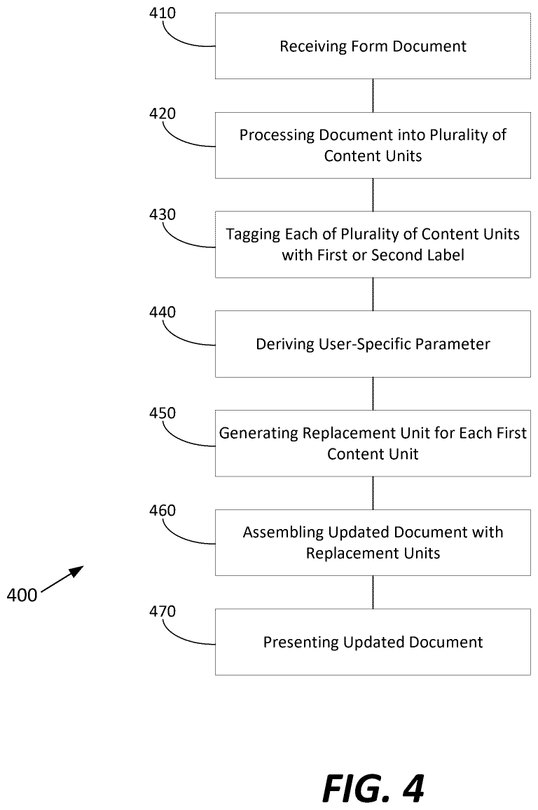

FIG. 4 is a flow chart illustrating an example method 400 of adapting content for multiple targets. The method 400, or one or more portions of the method 400, may be performed by the computing system 110 and, in particular, the label module 114, the personalized replacement module 117, and the assembly module 118 (shown in FIG. 1), in some embodiments. In contrast to the method 300 of FIG. 3, the method 400 may involve labelling content with alternative options from “static” and “dynamic,” and may involve derivation of a content parameter from the device that initiated the process.

The method 400 may include, at block 410, receiving a form document. The form document may be an amount of text (or content) created or drafted to be distributed to multiple targets. For example, the form document may be a user interface, a communication, etc. Accordingly, the form document may include placeholder text for certain portions, such as [NAME] indicating an address or [OFFER] as indicating a product for sale.

The method 400 may include, at block 420, processing the received document into a plurality of content units. In those embodiments in which the form document already includes placeholder text, the plurality of content units may be defined as the placeholder text and the portions of text between each placeholder text.

The method 400 may include, at block 430, tagging each of the plurality of content units with either a first or a second label. In some embodiments, the first label may be “dynamic” and the second label may be “static” (in alignment with method 300). In some embodiments, the first label may indicate a type of unacceptable (e.g., non-local or non-targeted) content, such as name, address, country, offer data, etc.) while the second label may indicate a different type of unacceptable content. In some embodiments, the first label may indicate unacceptable content included in the text of the document, and the second label may indicate placeholder text (that is inherently unacceptable).

The method 400 may include, at block 440, deriving a user-specific parameter from the device from which the form document was received. As discussed above with reference to the social graph engine 151, information regarding a user (e.g., the intended target for the document) may be extracted or data-mined from the device itself, including a pattern of user behavior (which may indicate an interest for a particular offer) or a location of the user (which may indicate local regulations to which the content must adhere).

The method 400 may include, at block 450, generating a replacement unit for each unit having the first label. In some embodiments, a generative AI model may be utilized to generate each replacement unit based on a prompt that includes the content unit having the first label, the derived user-specific parameter, and an instruction.

The method 400 may include, at block 460, assembling an updated document with the generated replacement units. In those embodiments in which the second label indicates a static content unit, the updated document may be assembled by stitching together the replacement units with the units having the second label based on an order of the first-labelled units with the second-labelled units in the originally-received form document.

The method 400 may include, at block 470, presenting the updated document. In some embodiments, the updated document may be presented on the device from which the form document was received. In some embodiments, the updated document may be presented on a device associated with the user identified as target, which may be different from the original device.

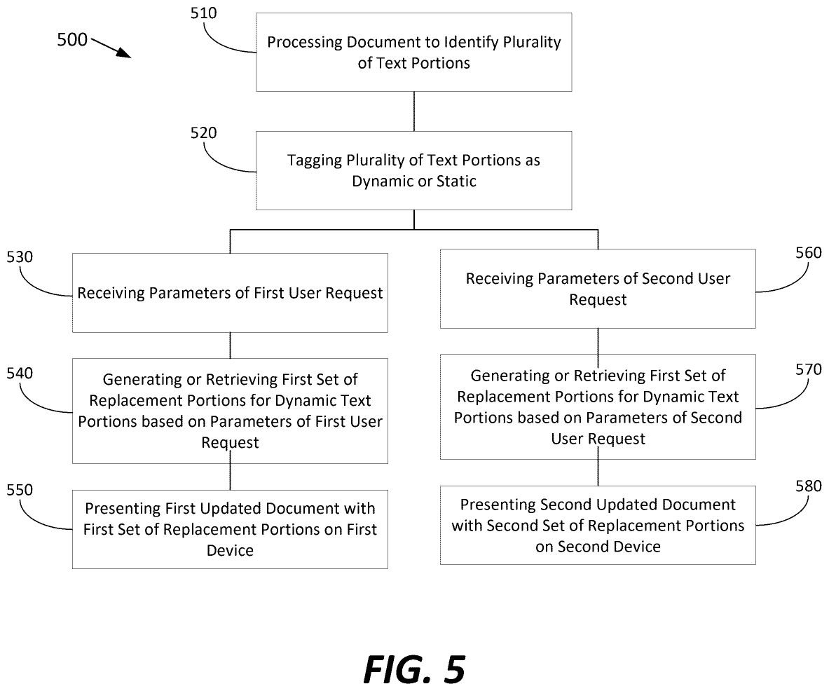

FIG. 5 is a flow chart illustrating an example method 500 of adapting content for multiple targets. The method 500, or one or more portions of the method 500, may be performed by the computing system 110 and, in particular, the label module 114, the contextual replacement module 116, the personalized replacement module 117, and the assembly module 118 (shown in FIG. 1), in some embodiments. In contrast to the method 300 of FIG. 3 and method 400 of FIG. 4, the method 500 may specifically address how content is adapted for different users.

The method 500 may include, at block 510, processing a received document into a plurality of text portions. First, the document may be processed with any suitable language detection model to identify individual words or terms, and may then be grouped into text portions based on syntax, content, or other grammatical marker.

The method 500 may include, at block 520, tagging each of the plurality of text portions as “dynamic” or “static.” As noted above, “dynamic” content may be content that is unacceptable for at least one target, such that the content may need to be adapted or adjusted for a particular target. “Static” content may be content that is non-local or acceptable to every target. Block 520 may further include labelling each unit of dynamic content as either contextual dynamic or personalized dynamic, and classifying each unit of dynamic content.

The method 500 may include, at block 530, receiving parameters of a first user request to access the document. The parameters may be indicative of a context of the request and the first user's identity, such as a user's name, address, location (e.g., to accommodate local regulations), or preferences. In some embodiments, a first user device may send the first user request parameters directly for processing. In some embodiments, the first user request parameters may be extracted (or data-mined) from the first user device directly, such as by querying stored user data on interaction patterns, usage data, etc.

The method 500 may include, at block 540, generating a first set of replacement text portions based on the parameters of the first user request. A generative AI model may be utilized to produce the replacement text portions in response to prompts that specify the particular user parameter as well as the particular content portion intended to be replaced. In an embodiment, first replacement portions for contextual dynamic text portions may be generated in an offline process before the first user request is received, and first replacement portions for personalized dynamic text portions may be generated in response to the first user request being received. For example, the prompt for the generative AI model may include the user's name such that the generative model's response to the prompt would incorporate the user's name into the generated content.

The method 500 may include, at block 550, presenting a first updated document with the first set of replacement portions on the first device. In some embodiments, this first updated document may be a combination of the content portions labeled as “static” with the replacement text portions generated at block 540. Block 550 may include, for each contextual dynamic text unit in the document, retrieving a particular context-specific replacement text portions from a plurality of pre-generated context-specific replacement text portions for that dynamic text unit. The specific context-specific replacement text may be selected to match the context indicated in the parameters of the first user request.

The method 500 may include, at block 560, receiving parameters of a second user request. The second user request may be made by a second user that is different from the first user, and from a second user device that is different from the first user device. The user parameters may be indicative of indicative of a context of the request and the second user's identity, such as a user's name, address, location (e.g., to accommodate local regulations), or preferences. In some embodiments, the second user device may send the second user request parameters directly for processing. In some embodiments, the second user request parameters may be extracted (or data-mined) from the second user device directly, such as by querying stored user data on interaction patterns, usage data, etc. Because the first user request parameters and the second user request parameters may be extracted from different devices, the two sets of parameters may be different from each other, such that any content generated based on a particular parameter sets may differ from content generated according to the other.

The method 500 may include, at block 570, generating a second set of replacement text portions based on the parameters of the second user request and, at block 580, presenting a second updated document with the second set of replacement portions on the second device. In some embodiments, this second updated document may be a combination of the content portions labeled as “static” with the replacement text portions generated at block 560. In an embodiment, second replacement portions for contextual dynamic text portions may be generated in an offline process before the second user request is received, and second replacement portions for personalized dynamic text portions may be generated in response to the second user request being received. Block 570 may include, for each contextual dynamic text unit in the document, retrieving a particular context-specific replacement text portions from a plurality of pre-generated context-specific replacement text portions for that dynamic text unit. The specific context-specific replacement text may be selected to match the context indicated in the parameters of the second user request.

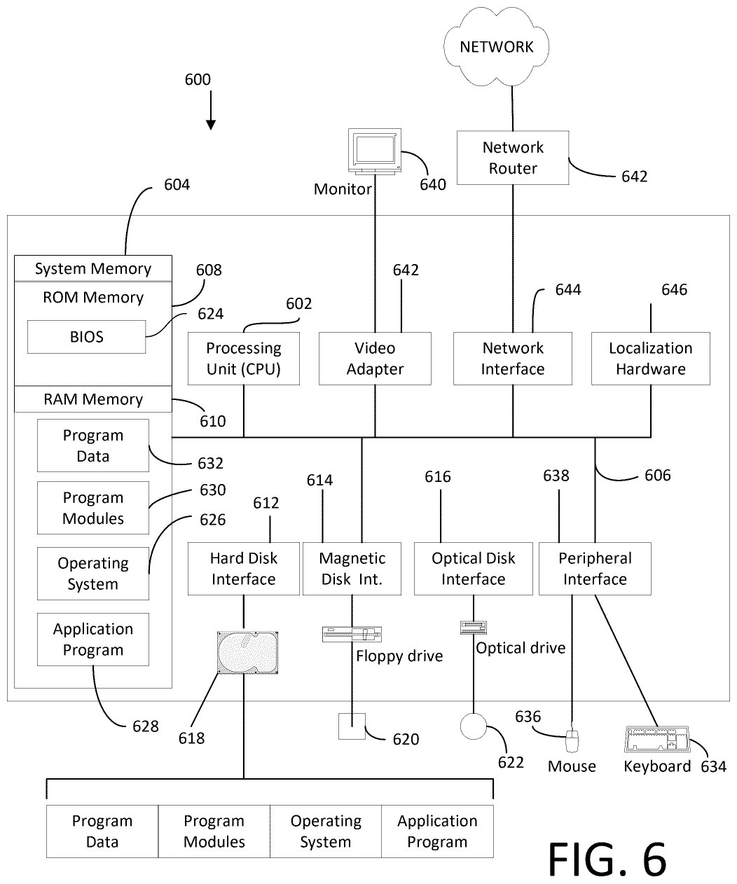

FIG. 6 is a diagrammatic view of an example embodiment of a user computing environment that includes a computing system environment 600, such as a desktop computer, laptop, smartphone, tablet, or any other such device having the ability to execute instructions, such as those stored within a non-transient, computer-readable medium. For example, the computing system environment 600 may be the user device 120 or a system hosting the computing system 110. In another example, one or more components of the computing system environment 600, such as one or more CPUs 602, RAM memory 610, network interface 644, and one or more hard disks 618 or other storage devices, such as SSD or other FLASH storage, may be included in the computing system 110. Furthermore, while described and illustrated in the context of a single computing system, those skilled in the art will also appreciate that the various tasks described hereinafter may be practiced in a distributed environment having multiple computing systems linked via a local or wide-area network in which the executable instructions may be associated with and/or executed by one or more of multiple computing systems.

In its most basic configuration, computing system environment 600 typically includes at least one processing unit 602 (e.g., processor 162) and at least one memory 604 (e.g., memory 164), which may be linked via a bus. Depending on the exact configuration and type of computing system environment, memory 604 may be volatile (such as RAM 610), non-volatile (such as ROM 608, flash memory, etc.) or some combination of the two. Computing system environment 600 may have additional features and/or functionality. For example, computing system environment 600 may also include additional storage (removable and/or non-removable) including, but not limited to, magnetic or optical disks, tape drives and/or flash drives. Such additional memory devices may be made accessible to the computing system environment 600 by means of, for example, a hard disk drive interface 612, a magnetic disk drive interface 614, and/or an optical disk drive interface 616. As will be understood, these devices, which would be linked to the system bus, respectively, allow for reading from and writing to a hard disk 618, reading from or writing to a removable magnetic disk 620, and/or for reading from or writing to a removable optical disk 622, such as a CD/DVD ROM or other optical media. The drive interfaces and their associated computer-readable media allow for the nonvolatile storage of computer readable instructions, data structures, program modules and other data for the computing system environment 600. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 600.

A number of program modules may be stored in one or more of the memory/media devices. For example, a basic input/output system (BIOS) 624, containing the basic routines that help to transfer information between elements within the computing system environment 600, such as during start-up, may be stored in ROM 608. Similarly, RAM 610, hard disk 618, and/or peripheral memory devices may be used to store computer executable instructions comprising an operating system 626, one or more applications programs 628 (which may include the functionality of the computing system 110 of FIG. 1 or one or more of its functional modules 114, 116, and 118, for example), other program modules 630, and/or program data 632. Still further, computer-executable instructions may be downloaded to the computing environment 600 as needed, for example, via a network connection.

An end-user may enter commands and information into the computing system environment 600 through input devices such as a keyboard 634 and/or a pointing device 636. While not illustrated, other input devices may include a microphone, a joystick, a game pad, a scanner, etc. These and other input devices would typically be connected to the processing unit 602 by means of a peripheral interface 638 which, in turn, would be coupled to bus. Input devices may be directly or indirectly connected to processor 602 via interfaces such as, for example, a parallel port, game port, firewire, or a universal serial bus (USB). To view information from the computing system environment 600, a monitor 640 or other type of display device may also be connected to bus via an interface, such as via video adapter 642. In addition to the monitor 640, the computing system environment 600 may also include other peripheral output devices, not shown, such as speakers and printers.

The computing system environment 600 may also utilize logical connections to one or more computing system environments. Communications between the computing system environment 600 and the remote computing system environment may be exchanged via a further processing device, such a network router 642, that is responsible for network routing. Communications with the network router 642 may be performed via a network interface component 644. Thus, within such a networked environment, e.g., the Internet, World Wide Web, LAN, or other like type of wired or wireless network, it will be appreciated that program modules depicted relative to the computing system environment 600, or portions thereof, may be stored in the memory storage device(s) of the computing system environment 600.

The computing system environment 600 may also include localization hardware 646 for determining a location of the computing system environment 600. In embodiments, the localization hardware 646 may include, for example only, a GPS antenna, an RFID chip or reader, a WiFi antenna, or other computing hardware that may be used to capture or transmit signals that may be used to determine the location of the computing system environment 600.

In some embodiments, a system may include a processor; and a non-transitory computer readable medium having stored thereon instructions that may be executable by the processor to cause the system to perform operations. These operations may include receiving a document from a user computing device, the document comprising a plurality of text portions; tagging, via a first machine learning model, each of the plurality of text portions as either dynamic or static based on at least one characteristic of the respective text portion; receiving, from the user computing device, an indication of a content parameter; generating, via a second machine learning model for each of the plurality of text portions tagged as dynamic, a replacement portion based on the content parameter; and transmitting, to the user computing device, an updated document including a plurality of replacement portions and the plurality of text portions tagged as static.

In some of these embodiments, the first machine learning model may include a predictive artificial intelligence (AI) model, and the second machine learning model may include a generative AI model.

In some of these embodiments, the first machine learning model may be trained by receiving a training dataset including a plurality of training text portions and a plurality of labels corresponding to the plurality of training text portions, generating, by the first machine learning model, a plurality of predicted labels corresponding to the plurality of training text portions, and adjusting the first machine learning model based on a comparison of the plurality of predicted labels to the plurality of labels in the training dataset.

In some of these embodiments, the content parameter may include a location-specific regulation, and generating the replacement portion may include identifying at least one of the plurality of text portions tagged as dynamic as including content that conflicts with the location-specific regulation, and generating a text portion that removes the conflicting content or replaces the conflicting content with non-conflicting content.

In some of these embodiments, the presenting the updated document further may include translating a language of the updated document based on a location associated with the location-specific regulation.

In some of these embodiments, the content parameter may include a user identifier, and generating the replacement portion may include identifying at least one of the plurality of text portions tagged as dynamic as including user-identity content, and generating the replacement portion as a text portion that replaces the user-identity content with the user identifier.

In some of these embodiments, presenting the updated document may include assembling the updated document by replacing each of the plurality of text portions tagged as dynamic in the received document with the generated replacement portions, checking the updated document according to the received content parameter, and checking the updated document for proper syntax.

In some embodiments, a method for generating user-specific content may include receiving, from a device, a form document, processing the form document to identify a plurality of content units, tagging, by a machine learning model, each of the plurality of content units with a first or second label, deriving a user-specific parameter from the device, generating, for each of the plurality of content units tagged with the first label, a replacement content unit based on the user-specific parameter, assembling an updated document with a plurality of replacement content units and the plurality of content units tagged with the second label, and transmitting the updated document to the device for display on a graphical user interface (GUI) of the device.

In some of these embodiments, the machine learning model may be trained by receiving a training dataset including a plurality of training content units and a plurality of labels corresponding to the plurality of training content units, generating, by the machine learning model, a plurality of predicted labels corresponding to the plurality of training content units, and adjusting the machine learning model based on a comparison of the plurality of predicted labels to the plurality of labels in the training dataset.

In some of these embodiments, the method may further include receiving, via the GUI of the device, an input regarding the updated document, wherein the machine learning model may be trained according to the received input.

In some of these embodiments, the user-specific parameter may include a location of the device, and the method further may include determining a location-specific regulation associated with the location of the device, and generating the replacement content unit may include identifying at least one of the plurality of content units tagged with the first label as including content that conflicts with the location-specific regulation, and generating a content unit that removes the conflicting content or replaces the conflicting content with non-conflicting content.

In some of these embodiments, transmitting the updated document further may include translating the updated document based on a location associated with the location-specific regulation.

In some of these embodiments, the user-specific parameter may include a user identifier, and generating the replacement content unit may include identifying at least one of the plurality of content units tagged with the first label as including user-identity content, and generating a content unit that replaces the user-identity content with the user identifier.

In some of these embodiments, the assembling the updated document may include checking the updated document according to the received user-specific parameter, and checking the updated document for proper syntax.

In some embodiments, a system may include a processor, and a non-transitory computer readable medium having stored thereon instructions that may be executable by the processor to cause the system to perform operations. These operations may include processing a document to identify a plurality of text portions, tagging, via a first machine learning model, each of the plurality of text portions as either dynamic or static based on at least one characteristic of the respective text portion, receiving, from a first device, an indication of a first user parameter, generating, via a second machine learning model for the plurality of text portions tagged as dynamic, a first set of replacement portions based on the first user parameter, transmitting, to the user computing device, a first updated document including the first set of replacement portions and the plurality of text portions tagged as static, receiving, from a second device, an indication of a second user parameter, generating, via the second machine learning model for the plurality of text portions tagged as dynamic, a second set of replacement portions based on the second user parameter, and transmitting, to the user computing device, a second updated document including the second set of replacement portions and the plurality of text portions tagged as static.

In some of these embodiments, the first machine learning model may include a predictive artificial intelligence (AI) model, and the second machine learning model may include a generative AI model.

In some of these embodiments, the first machine learning model may be trained by receiving a training dataset including a plurality of training text portions and a plurality of labels corresponding to the plurality of training text portions, generating, by the first machine learning model, a plurality of predicted labels corresponding to the plurality of training text portions, and adjusting the first machine learning model based on a comparison of the plurality of predicted labels to the plurality of labels in the training dataset.

In some of these embodiments, the first user parameter may include a location-specific regulation, and generating the first set of replacement portions may include identifying at least one of the plurality of text portions tagged as dynamic as including content that conflicts with the location-specific regulation, and generating a set of text portions that removes the conflicting content or replaces the conflicting content with non-conflicting content.

In some of these embodiments, the first user parameter may include a user identifier, and generating the first set of replacement portions may include identifying at least one of the plurality of text portions tagged as dynamic as including user-identity content, and generating a set of text portions that replaces the user-identity content with the user identifier.

In some of these embodiments, transmitting the first updated document may include assembling the first updated document by replacing each of the plurality of text portions tagged as dynamic in the received document with the first set of replacement portions, checking the first updated document according to the first user parameter, and checking the first updated document for proper syntax.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A system comprising:
a processor; and
a non-transitory computer readable medium having stored thereon instructions that are executable by the processor to cause the system to perform operations comprising:
receiving a document from a user computing device, the document comprising a plurality of text portions;
tagging, via a first machine learning model, each of the plurality of text portions as either dynamic or static based on at least one characteristic of the respective text portion;
receiving, from the user computing device, an indication of a content parameter;
generating, via a second machine learning model for each of the plurality of text portions tagged as dynamic, a replacement portion based on the content parameter; and
transmitting, to the user computing device, an updated document comprising a plurality of replacement portions and the plurality of text portions tagged as static.

2. The system of claim 1, wherein the first machine learning model comprises a predictive artificial intelligence (AI) model, and the second machine learning model comprises a generative AI model.

3. The system of claim 1, wherein the first machine learning model is trained by:
receiving a training dataset comprising a plurality of training text portions and a plurality of labels corresponding to the plurality of training text portions;
generating, by the first machine learning model, a plurality of predicted labels corresponding to the plurality of training text portions; and
adjusting the first machine learning model based on a comparison of the plurality of predicted labels to the plurality of labels in the training dataset.

4. The system of claim 1, wherein:
the content parameter comprises a location-specific regulation, and generating the replacement portion comprises:
identifying at least one of the plurality of text portions tagged as dynamic as including content that conflicts with the location-specific regulation; and
generating a text portion that removes the conflicting content or replaces the conflicting content with non-conflicting content.

5. The system of claim 4, wherein the transmitting the updated document further comprises translating a language of the updated document based on a location associated with the location-specific regulation.

6. The system of claim 1, wherein:
the content parameter comprises a user identifier, and
generating the replacement portion comprises:
identifying at least one of the plurality of text portions tagged as dynamic as including user-identity content; and
generating the replacement portion as a text portion that replaces the user-identity content with the user identifier.

7. The system of claim 1, wherein the transmitting the updated document comprises:
assembling the updated document by replacing each of the plurality of text portions tagged as dynamic in the received document with the generated replacement portions;
checking the updated document according to the received content parameter; and
checking the updated document for proper syntax.

8. A method for generating user-specific content, the method comprising:
receiving, from a device, a form document;
processing the form document to identify a plurality of content units;
tagging, by a machine learning model, each of the plurality of content units with a first or second label;
deriving a user-specific parameter from the device;
generating, for each of the plurality of content units tagged with the first label, a replacement content unit based on the user-specific parameter;
assembling an updated document with a plurality of replacement content units and the plurality of content units tagged with the second label; and
transmitting the updated document to the device for display on a graphical user interface (GUI) of the device.

9. The method of claim 8, wherein the machine learning model is trained by:
receiving a training dataset comprising a plurality of training content units and a plurality of labels corresponding to the plurality of training content units;
generating, by the machine learning model, a plurality of predicted labels corresponding to the plurality of training content units; and
adjusting the machine learning model based on a comparison of the plurality of predicted labels to the plurality of labels in the training dataset.

10. The method of claim 8, further comprising receiving, via the GUI of the device, an input regarding the updated document,
wherein the machine learning model is trained according to the received input.

11. The method of claim 8, wherein:
the user-specific parameter comprises a location of the device,
the method further comprises determining a location-specific regulation associated with the location of the device, and
generating the replacement content unit comprises:
identifying at least one of the plurality of content units tagged with the first label as including content that conflicts with the location-specific regulation; and
generating a content unit that removes the conflicting content or replaces the conflicting content with non-conflicting content.

12. The method of claim 11, wherein the transmitting the updated document further comprises translating the updated document based on a location associated with the location-specific regulation.

13. The method of claim 8, wherein:
the user-specific parameter comprises a user identifier, and
generating the replacement content unit comprises:
identifying at least one of the plurality of content units tagged with the first label as including user-identity content; and
generating a content unit that replaces the user-identity content with the user identifier.

14. The method of claim 8, wherein the assembling the updated document comprises:
checking the updated document according to the received user-specific parameter; and
checking the updated document for proper syntax.

15. A system comprising:
a processor; and
a non-transitory computer readable medium having stored thereon instructions that are executable by the processor to cause the system to perform operations comprising:
processing a document to identify a plurality of text portions;
tagging, via a first machine learning model, each of the plurality of text portions as either dynamic or static based on at least one characteristic of the respective text portion;
receiving, from a first device, an indication of a first user parameter;
generating, via a second machine learning model for the plurality of text portions tagged as dynamic, a first set of replacement portions based on the first user parameter;
transmitting, to the user computing device, a first updated document comprising the first set of replacement portions and the plurality of text portions tagged as static;
receiving, from a second device, an indication of a second user parameter;
generating, via the second machine learning model for the plurality of text portions tagged as dynamic, a second set of replacement portions based on the second user parameter; and
transmitting, to the user computing device, a second updated document comprising the second set of replacement portions and the plurality of text portions tagged as static.

16. The system of claim 15, wherein the first machine learning model comprises a predictive artificial intelligence (AI) model, and the second machine learning model comprises a generative AI model.

17. The system of claim 15, wherein the first machine learning model is trained by:
receiving a training dataset comprising a plurality of training text portions and a plurality of labels corresponding to the plurality of training text portions;
generating, by the first machine learning model, a plurality of predicted labels corresponding to the plurality of training text portions; and
adjusting the first machine learning model based on a comparison of the plurality of predicted labels to the plurality of labels in the training dataset.

18. The system of claim 15, wherein:
the first user parameter comprises a location-specific regulation, and
generating the first set of replacement portions comprises:
identifying at least one of the plurality of text portions tagged as dynamic as including content that conflicts with the location-specific regulation; and
generating a set of text portions that removes the conflicting content or replaces the conflicting content with non-conflicting content.

19. The system of claim 15, wherein:
the first user parameter comprises a user identifier, and
generating the first set of replacement portions comprises:
identifying at least one of the plurality of text portions tagged as dynamic as including user-identity content; and
generating a set of text portions that replaces the user-identity content with the user identifier.

20. The system of claim 15, wherein the transmitting the first updated document comprises:
assembling the first updated document by replacing each of the plurality of text portions tagged as dynamic in the received document with the first set of replacement portions;
checking the first updated document according to the first user parameter; and
checking the first updated document for proper syntax.
